(19) United States
(12) Patent Application Publication
(10) Pub. No.: US 2011/0131317 A1
(43) Pub. Date: Jun. 2, 2011

(54) Coverage Gap Detection In Wireless Networks

(75) Inventors: Susan W. Sanders, Bridgewater, NJ (US); Amit Mukhopadhyay, Westfield, NJ (US)

(73) Assignee: Alcatel-Lucent USA Inc., Murray Hill, NJ (US)

(21) Appl. No.: 12/628,798

(22) Filed: Dec. 1, 2009

(51) Int. Cl. G06F 15/16; G06F 17/30

(52) U.S. Cl. 709/224; 707/758; 707/E17.014

(57) ABSTRACT

Embodiments are described herein to provide a general approach to wireless coverage gap detection. One general approach involves network equipment comparing (101) a current wireless service map to a historical wireless service map, where the current wireless service map and the historical wireless service map correspond to the same wireless coverage area. If a difference in wireless service between the current wireless service map and the historical wireless service map exceeds a threshold, a potential wireless coverage problem is reported (102). Such an approach may be able to detect network performance problems related to antenna misalignment/malfunction in an effort to minimize the service interruption to subscribers.

### FIELD OF THE INVENTION

The present invention relates generally to communications and, in particular, to detection of coverage problems in wireless communication systems.

### BACKGROUND OF THE INVENTION

Over time, and especially after a storm with strong winds, base station antennas may go out of alignment. See, for example, wireless network 200 in FIG. 2. This situation may result in sub-optimal RF coverage, which degrades overall system performance. Moreover, an antenna malfunction may not generate an alarm in the system. (Typically, in the case of an antenna being out of alignment, there are no alarms.) Only after customers start complaining about poor coverage, do operators take action. First, drive testing is performed to detect and verify the problem, and then finally a skilled technician is sent to repair the antenna. Thus, an approach that is better able to detect wireless coverage problems in networks is desirable.

### BRIEF DESCRIPTION OF THE DRAWINGS

FIG. 1 is a logic flow diagram of functionality performed in accordance with various embodiments of the present invention.

FIG. 2 illustrates an example of a rotated sector antenna and the sub-optimal RF coverage that may result.

FIG. 3 illustrates an example of a geo-binned RF coverage map for a serving cell/sector during a period of normal operation.

FIG. 4 illustrates an example of a geo-binned RF coverage map for a serving cell/sector during a period when one or more antennas are out of alignment.

FIG. 5 illustrates a geo-binned mapping of the difference between an RF coverage map for a serving cell/sector during a period of normal operation and a period when one or more antennas are out of alignment.

FIG. 6 is a logic flow diagram of functionality performed in accordance with certain particular embodiments of the present invention.

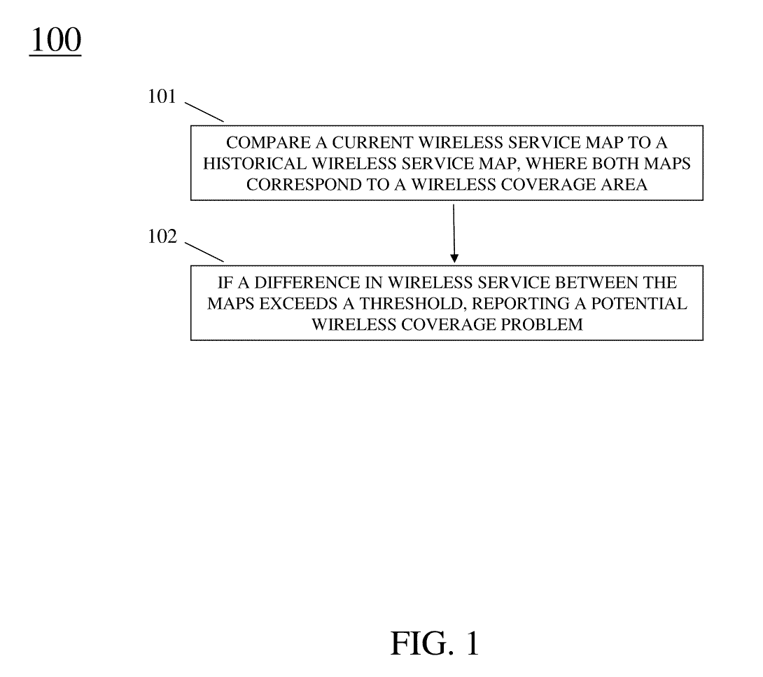

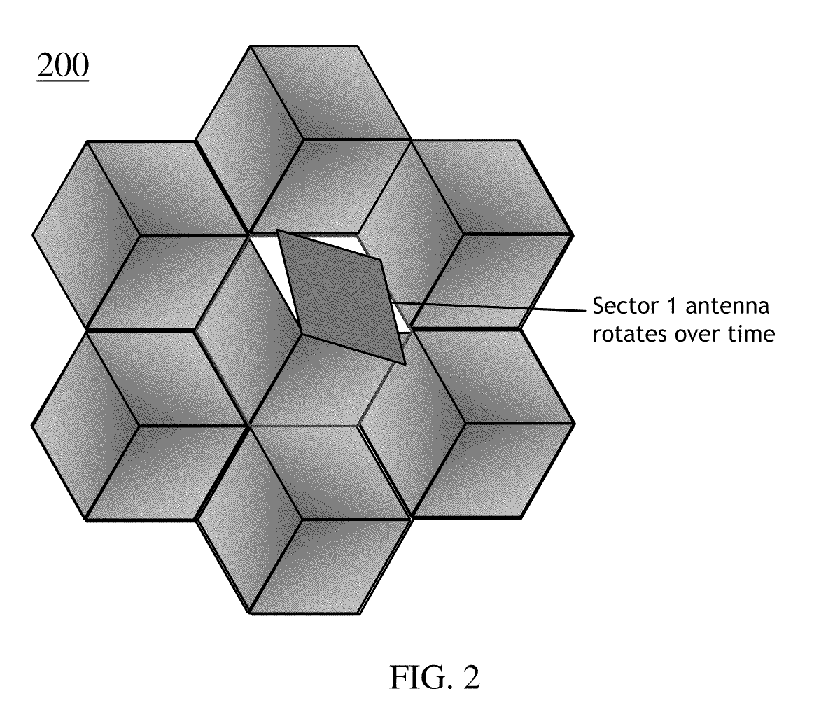

Specific embodiments of the present invention are disclosed below with reference to FIGS. 1-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

The present invention can be more fully understood with reference to FIGS. 1-6. FIG. 1 is a logic flow diagram of functionality performed in accordance with various embodiments of the present invention. Diagram 100 serves as a good generalization of many of the embodiments described in detail herein below. Thus, it is referenced now to provide a preview of the general approach to wireless coverage gap detection followed by many embodiments of the present invention. In diagram 100, network equipment compares (101) a current wireless service map to a historical wireless service map, where the current wireless service map and the historical wireless service map correspond to the same wireless coverage area. If a difference in wireless service between the current wireless service map and the historical wireless service map exceeds a threshold, a potential wireless coverage problem is reported (102). Such an approach may be able to detect network performance problems related to antenna misalignment/malfunction in an effort to minimize the service interruption to subscribers.

To provide a greater degree of detail in making and using various aspects of the present invention, a description of our approach to wireless coverage gap detection and a description of certain, quite specific, embodiments follows for the sake of example.

The basic idea underlying some of the embodiments described herein is to use the measurement reporting capability of a subscriber handset coupled with its GPS location reporting capability to create several service maps in a normal operation mode. These maps include subscriber usage maps and RF coverage maps (such as pilot Ec maps, pilot Ec/Io maps, channel quality index (CQI) maps, etc.). These normal operation maps are stored for reference, while current operation maps are created using data collected during the current operation period. Network equipment compares current operation maps with their corresponding normal operation maps. If any abnormality is detected, the operator is notified so that actions can be taken immediately to achieve a quick recovery.

These embodiments utilize the reporting capabilities of mobiles (or perhaps fixed wireless units) to generate service maps. In the case of low traffic periods when mobile stations are not actively making phone calls or transmitting data, the network may page units to acquire real-time reports for use in generating a current operation map.

Network equipment such as a server collects measurement and location information, and associates the information geographically into bins, i.e., geo-bins. For example, a geo-bin may be a 10 meter by 10 meter geographical area. The map information for a given geo-bin is computed based on the reports associated with locations falling within that geo-bin. A given service map contains a collection of a certain type (or types) of information associated with each geo-bin included in the map. For example, an RF coverage map may comprise pilot Ec/Io measurements binned geographically, while a usage map may comprise information about traffic patterns binned geographically. The maps may also contain information indicating their time period of collection or may be binned by or their period of collection. For example, this time information or binning may be based upon or indicate a time-of-day, day-of-the-week, time-of-the month, and/or time-of-the-year during which the information was collected.

In some embodiments, the normal operation maps include RF coverage maps and end mobile usage maps. The RF coverage maps can be generated by using drive test data or by using mobile over-the-air RF measurement reports during a normal operation period. This information is coupled with location information indicating where the measurement was collected. The mobile usage maps are created during different periods of the normal operation hours/days/weeks. For a given serving cell/sector the set of mobile usage maps create a usage profile. For example during the weekend, a given geographic bin has a very low voice usage (0.1 Erlangs, as an example). The same location during a weekday busy hour may have a much higher voice usage (1 Erlangs, as an example).

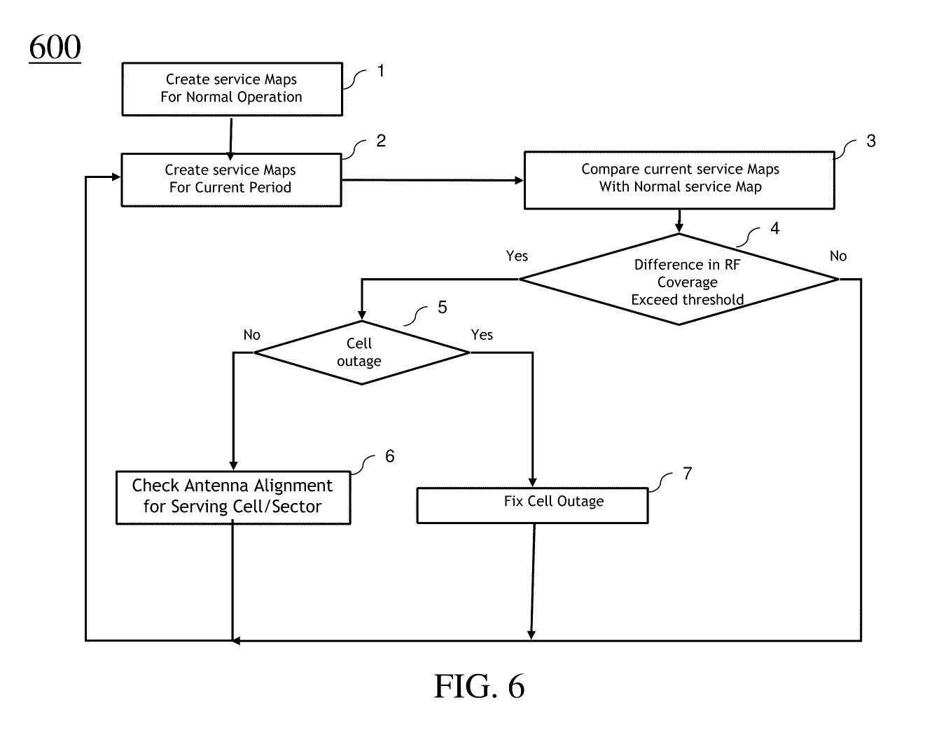

FIG. 6 is a logic flow diagram illustrating certain particular embodiments. Logic flow 600 is described below:

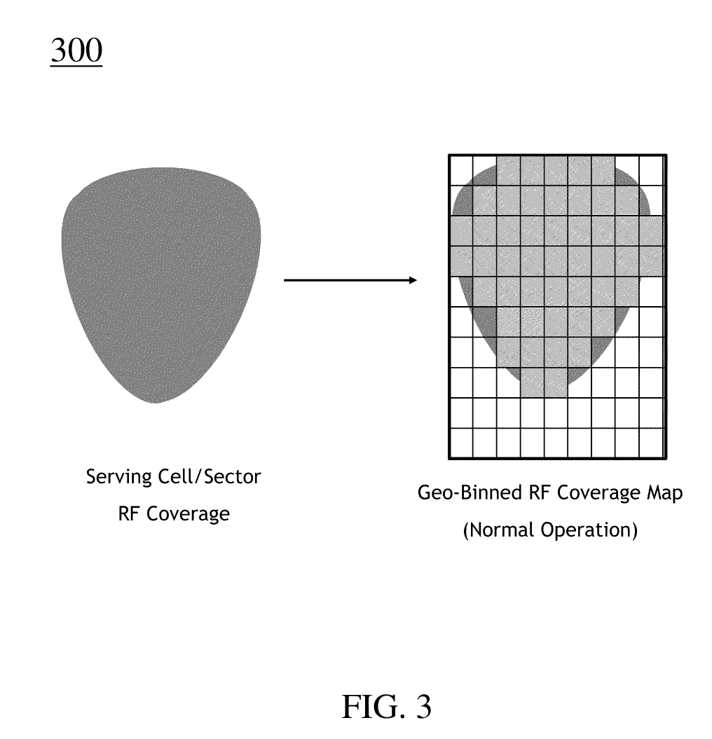

Step 1) Create reference normal service maps during drive tests, for example, and store it for future usage. See RF coverage map 300 in FIG. 3, for example.

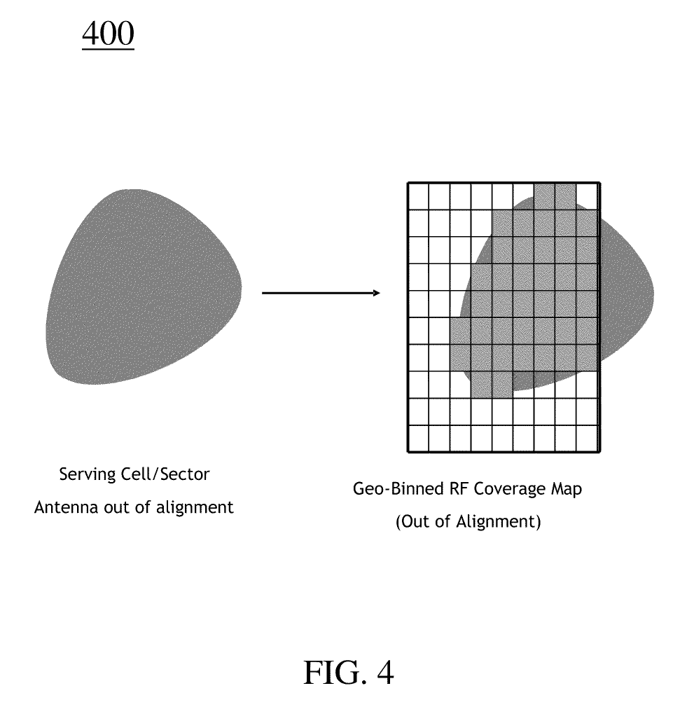

Step 2) Create service maps for current operation period. See RF coverage map 400 in FIG. 4, for example.

Step 3) Compare the current service map with the reference normal operations service map.

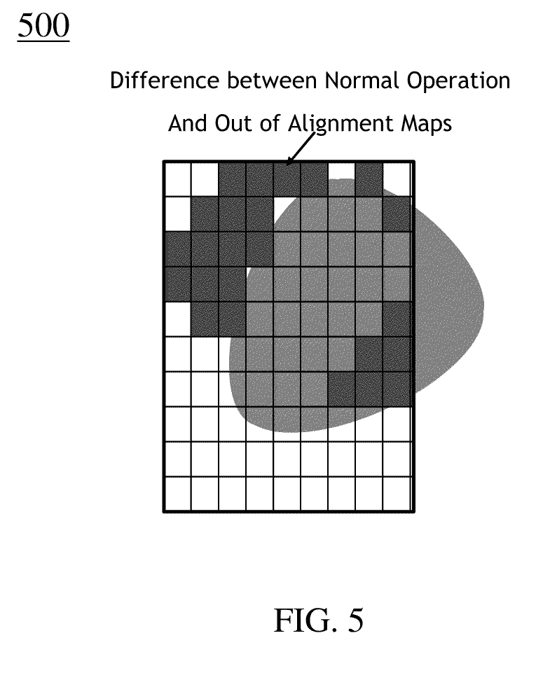

Step 4) If the difference in RF coverage between these two maps exceeds a certain threshold, then go to next step, otherwise go to step 2. For example, see a geo-binned mapping 500 in FIG. 5 of the difference between an RF coverage map during a period of normal operation and a period when one or more antennas are out of alignment.

Step 5) If the cell has an outage then go step 7. Otherwise (i.e., if the cell has antenna out of alignment or other antenna related problems), go to next step.

Step 6) Check antenna alignment, test antenna functionality. After re-alignments of antennas or fixing broken down antennas, go to step 2, (which recreates service maps after fixing the antenna problems and repeats the checking of current service maps with normal operation maps).

Step 7) Fix cell outage and go to step 2.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method, comprising:
comparing a current wireless service map to a historical wireless service map, wherein the current wireless service map and the historical wireless service map correspond to a wireless coverage area;
if a difference in wireless service between the current wireless service map and the historical wireless service map exceeds a threshold, reporting a potential wireless coverage problem.

2. The method as recited in claim 1, wherein the current wireless service map and the historical wireless service map correspond to similar time periods.

3. The method as recited in claim 3, wherein similar time periods comprise at least one of the same time-of-day, the same day-of-the-week, the same time-of-the month, or the same time-of-the-year.

4. The method as recited in claim 1, further comprising
generating the historical wireless service map using signal measurement reports from wireless units located within a particular geographic location.

5. The method as recited in claim 1, further comprising
generating the historical wireless service map using signal measurement information that includes at least one of pilot Ec, pilot Ec/Io or CQI, the signal measurement information being associated with a particular geographic location.

6. The method as recited in claim 1, further comprising
generating the current wireless service map using signal measurement reports from wireless units located within a particular geographic location.

7. The method as recited in claim 1, further comprising
generating the current wireless service map using signal measurement information that includes at least one of pilot Ec, pilot Ec/Io or CQI, the signal measurement information being associated with a particular geographic location.

8. An article of manufacture comprising a processor-readable storage medium storing one or more software programs which when executed by a processor perform the steps of the method of claim 1.

9. Network equipment in a communication system, the network equipment being configured to communicate with other equipment in the system, wherein the network equipment is operative to compare a current wireless service map to a historical wireless service map, wherein the current wireless service map and the historical wireless service map correspond to a wireless coverage area and to report a potential wireless coverage problem, if a difference in wireless service between the current wireless service map and the historical wireless service map exceeds a threshold.

10. The network equipment as recited in claim 9, wherein the network equipment is further operative to generate the historical wireless service map using signal measurement reports from wireless units located within a particular geographic location.

11. The network equipment as recited in claim 9, wherein the network equipment is further operative to generate the historical wireless service map using signal measurement information that includes at least one of pilot Ec, pilot Ec/Io or CQI, the signal measurement information being associated with a particular geographic location.

12. The network equipment as recited in claim 9, wherein the network equipment is further operative to generate the current wireless service map using signal measurement reports from wireless units located within a particular geographic location.

13. The network equipment as recited in claim 9, wherein the network equipment is further operative to generate the current wireless service map using signal measurement information that includes at least one of pilot Ec, pilot Ec/Io or CQI, the signal measurement information being associated with a particular geographic location.
